(19) United States
(12) Patent Application Publication
(10) Pub. No.: US 2006/0166170 A1
(43) Pub. Date: Jul. 27, 2006

(54) Method and apparatus for disinfecting dental tools during an examination procedure

(76) Inventor: Gayle Masters, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/045,639

(22) Filed: Jan. 27, 2005

(51) Int. Cl. A61C 5/00; A61C 3/04

(52) U.S. Cl. 433/215; 433/49

(57) ABSTRACT

A method for cleansing a dental instrument during the performance of a probing procedure on a patient as part of a dental examination comprising: (a) obtaining an antimicrobial cleansing device comprising an absorbing medium having an antimicrobial agent supported therein; (b) supporting the antimicrobial cleansing device on the body of a practitioner; (c) initiating a probing procedure as part of a dental examination; (d) probing a periodontal region of a patient using a suitable dental instrument having a tip, wherein the tip contacts at least a portion of the periodontal region; (e) exposing the tip to the antimicrobial agent contained in the absorbing medium before moving to a subsequent periodontal region for the purpose of cleansing the tip and reducing the chance of introducing pathogens into the subsequent periodontal region; and (f) probing a subsequent periodontal region of the patient using the tip of the dental instrument, as cleansed, wherein the tip contacts at least a portion of the subsequent periodontal region. To prevent cross-contamination of pathogens, the steps of probing are alternated with the step of exposing the dental tool to the absorbing medium and the antimicrobial contained therein. Also disclosed are various antimicrobial cleansing devices for conveniently supporting the absorbing medium and the antimicrobial agent about the body of the practitioner.

### FIELD OF THE INVENTION

This invention relates to the practice of dentistry, and particularly the methods and procedures of dental hygiene. More specifically, the present invention relates to a method and apparatus for applying an antimicrobial agent to dental instruments during the various procedures performed by a dentist, dental assistant, or dental hygienist, such as root-planing, scaling, and cleaning of teeth, for the purpose of disinfecting, sanitizing, sterilizing or otherwise cleaning the dental instrument, and particularly the tip of the dental instrument.

### BACKGROUND OF THE INVENTION AND RELATED ART

During a typical dental examination, a patient will undergo one or more probing procedures, such as scaling, root-planing and/or cleaning teeth using a suitable dental instrument, such as a stainless steel, sharp-edged curette or scaler. The scaler is typically used to probe subgingivally and coronally (below the tooth surface and above the tooth surface, respectively) to remove bacteria, plaque, calculus, as well as blood and exudate/pus that may also be present. These contaminants or remains may reside in what are termed as pockets or pocket sites, (e.g., a periodontal region). A healthy pocket depth measures 2-3 millimeters. If gingivitis and inflammation is present, the pocket depth can increase to a measurement of 4-5 mm. Periodontal disease exists if the pocket measurement is 6 mm or greater, whereby the supporting tissue and bone deteriorates around the tooth. The deeper the pocket the less oxygen there is and the bacteria become anaerobic, which can rapidly cause further breakdown of the supporting gingival and bone. If bacteria from a deep pocket is introduced into a non-infected site or periodontal region, the bacteria can live in that new pocket site if uninterrupted by oxygen, thus contaminating this previously uncontaminated region.

During a dental examination, various probing procedures may be performed to help prevent decay, gingivitis and periodontal disease and improve the health of the patient by cleaning these pocket sites and removing the harmful bacterial or remains. However, the prior art has not sufficiently addressed the problems of cross-contamination that may occur during such a probing procedure.

To prevent cross-contamination, the tip of the dental instrument should be wiped clean after contacting one periodontal region and before contacting another or subsequent periodontal region. However, prior art devices used by practitioners simply include the use of a cotton gauze pad placed between the index and middle fingers of the hand opposite of the one holding the dental instrument. The gauze pad is used to wipe the tip clean of collected debris while cleaning the teeth. Several deficiencies are inherently associated with such device and method. First, wiping the tip to free it of debris only addresses cleansing on a macro level. There is nothing in the gauze to disinfect or otherwise clean the tip on a micro level, meaning there is no disinfecting of the tip to remove bacteria and other harmful pathogens. Thus, probing two different periodontal regions potentially subjects the patient to cross-contamination. Second, there is a significant risk of pricking the skin with the tip, especially if the gauze slips or the practitioner is not paying close attention to the wiping process, as the wiping medium is in close proximity to the fingers of the practitioner. This is especially of concern when dealing with diseased patients, such as those with AIDS, HIV, or Hepatitis.

Another prior art method used to wipe the dental instrument involves placing the gauze pad on the bib cover of the patient. This is problematic in that no cleansing on the micro level is achieved. In addition, it increases the chance of poking the patient.

If the gauze pad is left on the dental tray, time-consuming interruptive and increased excessive body movement is required, which, over the long run, can be physically detrimental to the musculoskeletal upper half of the body of the practitioner.

### SUMMARY OF THE INVENTION

In light of the problems and deficiencies inherent in the prior art, the present invention seeks to overcome these by providing an antimicrobial cleansing device, and various methods of using the antimicrobial cleansing device during a dental examination, for disinfecting or otherwise cleansing or sterilizing the tip of a dental instrument (such as a dental scaler or curette).

In accordance with the invention as embodied and broadly described herein, the present invention features a method for cleansing a dental instrument during the performance of a probing procedure on a patient as part of a dental examination. The method comprises: (a) obtaining an antimicrobial cleansing device comprising an absorbing medium having an antimicrobial agent supported therein; (b) supporting the antimicrobial cleansing device on the body of a practitioner; (c) initiating a probing procedure as part of a dental examination; (d) probing a periodontal region of a patient using a suitable dental instrument having a tip, wherein the tip contacts at least a portion of the periodontal region; (e) exposing the tip to the antimicrobial agent contained in the absorbing medium before moving to a subsequent periodontal region for the purpose of cleansing the tip and reducing the chance of introducing pathogens into the subsequent periodontal region; and (f) probing a subsequent periodontal region of the patient using the tip of the dental instrument, as cleansed, wherein the tip contacts at least a portion of the subsequent periodontal region.

The present invention further features a method for reducing the cross-contamination of bacteria between periodontal regions during a probing procedure as part of a dental examination. This particular method comprises: (a) probing a periodontal region of a patient using a suitable dental instrument having a tip, wherein the tip contacts at least a portion of the periodontal region; (b) exposing the tip to an antimicrobial agent contained in an absorbing medium of an antimicrobial cleansing device before moving to a subsequent periodontal region for the purpose of cleansing the tip and reducing the chance of introducing pathogens into the subsequent periodontal region; (c) probing a subsequent periodontal region of the patient using the tip of the dental instrument, as cleansed, wherein the tip contacts at least a portion of the subsequent periodontal region; and (d) repeating the steps of probing a periodontal region, exposing the tip to the antimicrobial agent, and probing exposing a subsequent periodontal region as many times as necessary during the probing procedure.

The present invention also features an antimicrobial cleansing device for disinfecting a dental instrument during a probing procedure as part of a dental examination. The antimicrobial cleansing device comprises: (a) an absorbing medium configured to support an antimicrobial agent therein; (b) an antimicrobial agent supported within the absorbing medium and configured to cleanse a tip of a dental instrument upon contact of the tip with the absorbing medium; and (c) means for supporting the absorbing medium from the body of a practitioner.

In one exemplary embodiment, the absorbing medium comprises a self-adhesive, antimicrobial, pre-soaked, one inch square, polyurethane sponge that is affixed to the back of the opposing working hand with a double-sided adhesive strip, wherein the antimicrobial soaked sponge is used as a sterile wipe for the sharp edged tip of the dental instrument used by the practitioner to remove bacteria, plaque, calculus, blood, exudate and all other foreign matter from the teeth and periodontal pockets of a patient. The antimicrobial contained within the sponge is a solution comprising chlorhexadine gluconate two percent (2%), which serves to disinfect the tip of the dental instrument as it is wiped, and thus, reduce the chance of introducing pathogens into a non-infected pocket site. Upon wiping or otherwise exposing the tip of the dental instrument to the sponge, the potential for cross-contamination from one pocket/tooth site to a subsequent pocket/tooth site is reduced as the tip is cleansed of contaminants or pathogens (i.e., disinfected) by the antimicrobial agent. A layer of adhesive, such as double-stick tape, on the under surface of the sponge functions to secure the sponge to the back of the gloved hand, freeing up that hand to hold other things such as a mirror or to retract the lips from the patient.

In another exemplary embodiment, the antimicrobial cleansing device comprises a structural means configured to receive and support the absorbing medium off of the hand or body of the user. The structural means may comprise a ring or ring-like structure having a ring portion configured to engage the finger of the practitioner, as well as a portion configured to receive and support the absorbing medium.

The size and shape of the present invention absorbing medium allow it to be light-weight, smaller, less cumbersome, and easier to apply and use as compared to the prior art devices described above, along with their associated methods of use. The present invention antimicrobial device will effectively prevent or reduce the likelihood of bacterial cross-contamination, and will help reduce the chance for injury by encouraging proper biomechanics and musculoskeletal health of the practitioner, thus improving career longevity.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of the antimicrobial cleansing device according to a first exemplary embodiment of the present invention;

FIG. 2 illustrates a perspective view of the antimicrobial cleansing device according to a second exemplary embodiment of the present invention;

FIG. 3 illustrates a perspective view of the antimicrobial cleansing device according to a third exemplary embodiment of the present invention;

FIG. 4 illustrates a flow diagram of an exemplary method for cleansing a dental instrument during the performance of a probing procedure on a patient as part of a dental examination; and

FIG. 5 illustrates a flow diagram of an exemplary method for reducing the cross-contamination of bacteria between periodontal regions during a probing procedure as part of a dental examination.

### DETAILED DESCRIPTION OF EXEMPLARY EMBODIMENTS

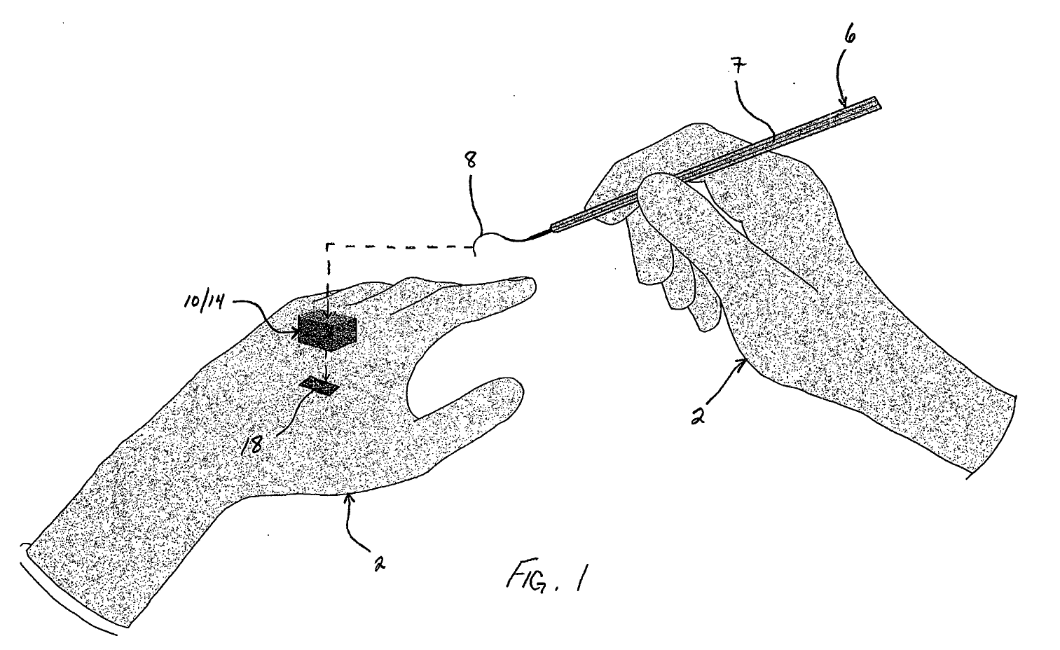

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 5, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

In general, the present invention describes various methods and devices for applying an antimicrobial disinfectant to dental instruments, or for cleansing dental instruments during a dental examination, namely during a probing procedure, for one or more purposes, including preventing or reducing the likelihood of cross-contaminating the periodontal regions or locations with the dental instrument.

At the outset, it will be advantageous to set forth the definitions of several terms or phrases that are used herein in describing the present invention. The term “probing” or the phrase “probing procedure,” as well as similar terminology or phraseology, as used herein, shall be understood to mean any procedure performed by a dentist, dental assistant, dental hygienist, or other qualified practitioner using a tool, such as a scaler or curette, to explore the periodontal regions of a patient's mouth, including tooth and gum regions, during a dental or similar procedure or examination for the purpose of removing bacteria, plaque, calculus, and any other contaminants. Probing may be carried out subgingivally (below the tooth surface) or coronally (above or at the tooth surface). Exemplary probing procedures include, but are not limited to, scaling, root-planing, and the cleaning of teeth.

The phrase “dental instrument,” or similar phraseology, as used herein, shall be understood to mean any tool, preferably hand-held, used to probe the periodontal regions of a patient's mouth during a dental or similar procedure or examination. Dental instruments may be designed to probe subgingivally (below the tooth surface) or coronally (above or at the tooth surface) or both. Exemplary dental instruments include, but are not limited to, dental scalers, curettes, and others.

The phrase “periodontal region,” or similar phraseology, as used herein, shall be understood to mean any subgingival or coronal location within a patient's mouth. Periodontal regions may include, but are not limited to, pocket sites, tooth surfaces, etc.

The term “cleansing,” or similar terminology, as used herein, shall be understood to mean the disinfecting, sterilizing, sanitizing, or otherwise cleaning of the tip of a dental instrument and freeing it from pathogens, such as bacteria, that are causative of disease.

The following more detailed description is divided into two sections. These sections are intended only as a convenience for the reader, and are not meant to be limiting in any way.

### Antimicrobial Cleansing Device

The present invention comprises several exemplary embodiments of an antimicrobial cleansing device configured to provide the advantages described herein. Each of these embodiments are discussed below.

With reference to FIG. 1, illustrated is a perspective view of an exemplary antimicrobial cleansing device in use during a probing procedure of a dental examination. Specifically, FIG. 1 illustrates an antimicrobial cleansing device 10 comprising an absorbing medium 14 supported on the back of a hand 2, namely the left hand, of a practitioner. The absorbing medium 14 is removably attached to the hand 2 using an adhesive 18, such as glue, double-sided tape, etc., which adhesive may secure the absorbing medium 14 to a gloved or non-gloved hand. Indeed, many practitioner's wear or are required to wear gloves, such as latex rubber or vinyl gloves, for protection as doing so helps to minimize the risk of injury that may result from a stick or puncture inadvertently caused by a dental instrument contaminated with bacteria, possible blood-born pathogens or infectious diseases, such as herpes, hepatitis, and acquired immune deficiency syndrome (AIDS). Therefore, the present invention antimicrobial cleansing device 10 must be able to be utilized in conjunction with the wearing of such gloves by the practitioner.

The absorbing medium 14 is configured to contain or support therein one or more antimicrobial agents, or a solution containing an antimicrobial agent at least in part. Therefore, the absorbing medium 14 may comprise any suitable matrix or material capable of doing so. Essentially, the matrix or material used is preferably configured to facilitate the exposure of the tip of a dental instrument to the antimicrobial agent. Incidentally, an exemplary dental instrument shown in FIG. 1 comprises a scaler 6 having a handle portion 7 and a tip 8. Other dental instruments suitable for performing a probing procedure may be utilized with the antimicrobial cleansing device of the present invention, and therefore, the scaler 6 illustrated in the various figures is intended to be exemplary only, and not limiting in any way.

No matter the material used, the absorbing medium 14 must be configured to allow the tip 8 to be adequately cleansed or disinfected upon contact or interaction with the absorbing medium 14. As such, the absorbing medium 14 is also preferably, although not necessarily, deformable in order to improve the cleansing capabilities of the absorbing medium 14. Providing an absorbing medium with a deformable characteristic functions to more readily receive the tip 8 as it is brought into contact with the absorbing medium 14, as well as to more readily expose the tip 8 to the antimicrobial agent. As the tip 8 is brought into contact with the absorbing medium 14 and a sufficient amount of pressure is applied, the absorbing medium 14 deforms to some degree to somewhat envelop the tip 8. In addition, deformation of the absorbing device causes the antimicrobial agent contained therein, which is typically in fluid form, to displace, thus better exposing the tip 8 to the antimicrobial agent, and therefore achieving a better overall cleansing or disinfecting effect on the tip 8. Cleansing of the tip 8 may be further effectuated by displacing the tip 8 across the surface of the absorbing medium (e.g., wiping the tip 8) either in a unidirectional, bi-directional, or circular manner, or any combination of these.

The antimicrobial agent, which is the active ingredient, contained or supported within the absorbing medium may be comprised of a stand-alone or pure agent added alone to the absorbing medium, or one embodied in a solution comprising, at least in part or in a percent by weight, the antimicrobial agent, preferably as pre-determined, and one or more inactive ingredients, each also present in an amount by weight as preferably pre-determined. In most embodiments, the antimicrobial agent or solution containing the antimicrobial agent will be a liquid capable of extending to all parts of the absorbing medium. Types of antimicrobial agents include, but are not limited to, high ethyl alcohols or high ethyl alcohol solutions (which are fast-acting, broad spectrum antimicrobials), chlorhexadine gluconate, isopropyl alcohol, povidone, iodine, sodium hypochloride, systemic antibiotics, such as MET-AMOX and MET-CIPRO, topical antibiotics, topical antiseptics, and others. The amounts of these antimicrobial agents may vary depending upon the type of agent used, the solution embodying the agent, etc. In one exemplary embodiment, the antimicrobial agent comprises chlorhexadine gluconate present within a solution in an amount by weight between one tenth of one percent and twenty percent (0.1-20%), and preferably two-tenths of one percent (0.2%). In another exemplary embodiment, the antimicrobial agent comprises ethyl alcohol present within a solution in an amount by weight between one-tenth of one percent and eighty percent by weight (0.01%-80%). In another exemplary embodiment, the antimicrobial agent comprises sodium hypochloride present within a solution in an amount by weight between one-tenth of one percent and ten percent (0.1%-10%). Of course, as will be recognized by those skilled in the art, other percents by weight for the antimicrobial agent (and other ingredients, if a solution) are possible and contemplated herein. These are well known in the art and not specifically described in any greater detail. As such, those specifically recited herein should not be construed as limiting in any way.

In the exemplary embodiment shown in FIG. 1, the absorbing medium is constructed from an open-cell or porous polyurethane foam or sponge supported directly on the hand 2 of the practitioner. The advantage of using a foam or sponge is that the antimicrobial agent is easily contained therein. In addition, the foam or sponge readily receives the tip 8 by deforming to some degree in accordance with the amount of pressure as applied by the practitioner to the tip 8, and therefore, better exposing the tip 8 to the antimicrobial agent. Other materials that the absorbing medium 14 may be constructed from include, gauze, other types of polymer foams, and any other materials or mediums capable of absorbing and containing a liquid or semi-liquid therein, as well as allowing limited displacement of the liquid throughout the medium. The absorbing material 14 may vary in thickness and rigidity, although it may be desirable to use a spongy material for reasons of deformability. Moreover, the absorbing medium 14 may be perforated to enhance fluid flow and to reduce the weight of the device.

The absorbing medium 14 may be supported directly on the body of the practitioner in other locations besides the back of the hand 2. For example, as shown in the drawings and explained below, the absorbing medium may be supported on one of the fingers, the wrist, or arm of the practitioner, as is practical and/or preferred by the practitioner. Alternatively, as shown in the drawings and explained below, the absorbing medium may be contained within one or more structural members configured to support the absorbing medium on or from the body of the practitioner.

As indicated above, the absorbing medium 14 is configured to contain or support an antimicrobial agent or solution therein. As such, the absorbing medium 14 may comprise a pre-soaked configuration where the antimicrobial agent is placed within the absorbing medium prior to packaging. Alternatively, the antimicrobial agent may be added to the absorbing medium 14 by the practitioner upon obtaining the absorbing medium and just prior to use. Preferably, however, the absorbing medium 14 will be pre-soaked with the antimicrobial agent or antimicrobial solution and packaged accordingly, so that a practitioner is not required to add the antimicrobial prior to use. Providing a pre-soaked absorbing medium is advantageous in that better control of the type and amount of antimicrobial agent present within the absorbing medium is achieved. In addition, a pre-soaked absorbing medium will encourage disposal after each dental examination. Other advantages will be apparent to those skilled in the art.

Finally, the absorbing medium 14 may be configured to comprise any geometric shape, such as cubical, cylindrical, spherical, etc.

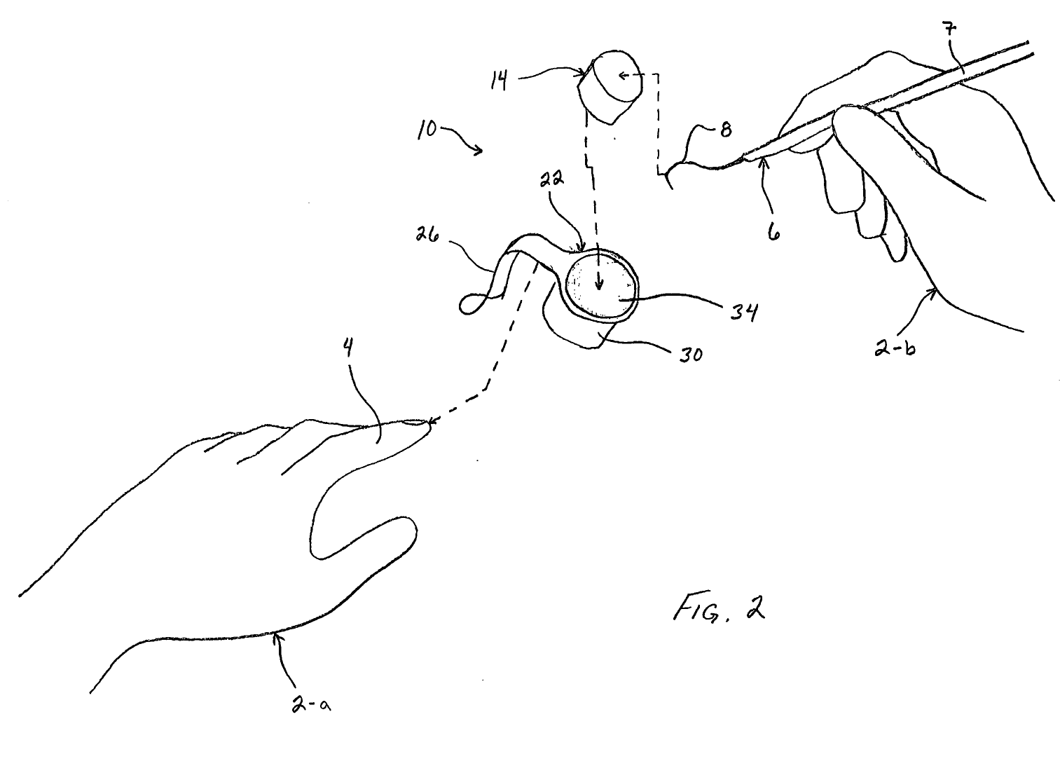

Referring now to FIG. 2, shown is a perspective view of the antimicrobial cleansing device according to a second exemplary embodiment of the present invention. Specifically, FIG. 2 illustrates the antimicrobial cleansing device 10 comprising a ring-like structure 22 having a ring member 26 that is configured to engage and support the ring-like structure 22 about a finger 4 of a practitioner, and a bowl 30 extending from the ring member 26, wherein the bowl 30 comprises an interior 34 configured to receive and support an absorbing medium 14 therein, as shown. The ring-like structure 22 shown in FIG. 2 is well known in the art and not specifically described herein. The absorbing medium 14 comprises a cylindrical sponge or foam element having an outer wall portion that fits within the inside wall of the bowl 30, and a bottom portion that rests against the bottom portion of the bowl 30, thus containing and supporting the absorbing medium 14 within the bowl. As discussed above, the absorbing medium is configured to contain an antimicrobial agent therein.

Once the absorbing medium 14 is properly placed or located within the bowl 30, the ring member 26 is placed on the finger 4 of the hand of the practitioner, shown as left hand 2-a, with the bowl 30 and absorbing member 14 facing upward, thus positioned above the hand 2-a. In an opposite hand, shown as right hand 2-b, the practitioner retrieves or obtains a scaler 6 having a handle portion 7 and a tip 8. During a dental examination, and particularly a probing procedure, the scaler is used to perform one of scaling, root-planing, cleaning of teeth, etc. using the sharp edge of the tip 8 for one or more purposes, such as to remove bacteria, plaque, and calculus. Upon probing one periodontal region, the tip 8 may become contaminated with bacteria or other contaminants. This can be problematic as it is common to probe several periodontal regions during a single dental examination. Thus, in the event the tip 8 becomes contaminated from probing one periodontal region, it is likely that cross-contamination will occur as the tip is subsequently moved to another periodontal region. In other words, if the tip 8 becomes contaminated from the probing of one periodontal region, it is likely that the probing of a subsequent periodontal region without first cleansing the tip will result in the introduction of contaminants to the subsequent region.

To prevent cross-contamination, the present invention antimicrobial cleansing device 10 is designed to receive the tip 8 and expose the tip 8 to the antimicrobial agent contained therein for the purpose of disinfecting or otherwise cleaning the tip 8 prior to it being moved to a subsequent periodontal region. Once cleansed, the tip 8 can be moved to a subsequent periodontal region without introducing contaminants to the subsequent region, thus preventing or minimizing cross-contamination.

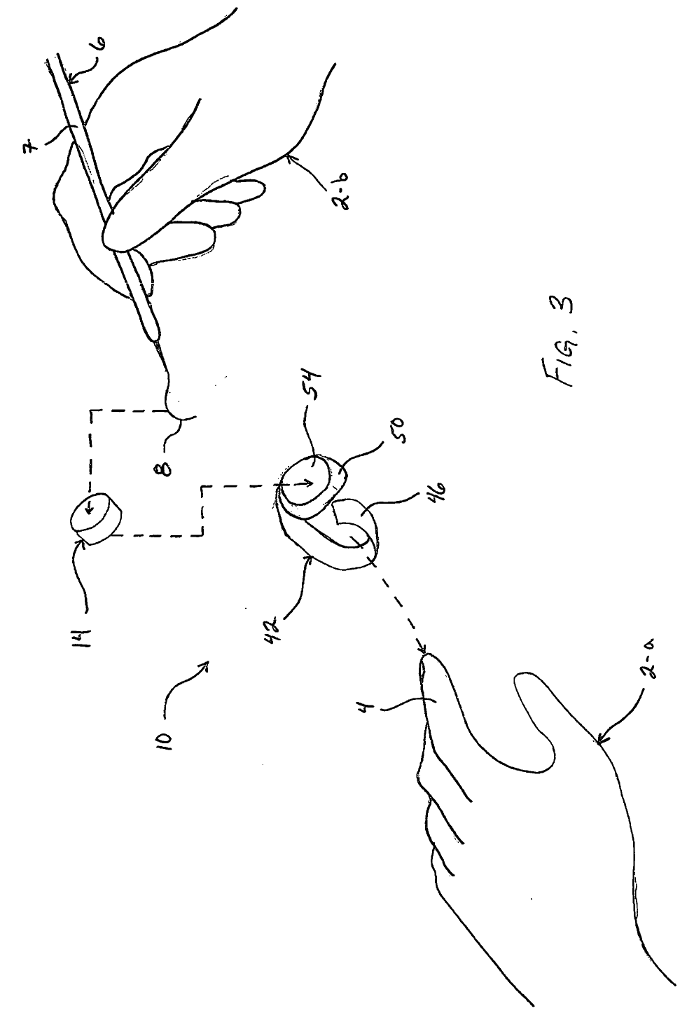

FIG. 3 illustrates a perspective view of the antimicrobial cleansing device according to a third exemplary embodiment of the present invention. Specifically, FIG. 3 illustrates the antimicrobial cleansing device 10 as comprising a ring-like structure 42 having a ring member 46 that is configured to engage and support the ring-like structure 42 about a finger 4 of a practitioner, and a support member 50 extending from the ring member 46, wherein the support member 50 comprises a surface 54 formed thereon configured to receive and support an absorbing medium 14 thereon, as shown. The ring-like structure 22 shown in FIG. 3 is well known in the art and not specifically described herein. The absorbing medium 14 comprises a cylindrical sponge or foam element having a bottom surface that rests on and removably attaches to the surface 54, having a circular configuration, of the support member 50. The absorbing medium 14 attaches to the surface 54 using any known adhesive 18, such as a double-sided adhesive strip. As discussed above, the absorbing medium is configured to contain an antimicrobial agent therein.

Similar to the embodiments of FIGS. 1 and 2, once the absorbing medium 14 is properly placed or located within the bowl 30, the ring member 26 is placed on the finger 4 of the hand of the practitioner, shown as left hand 2-a, with the surface 54 and absorbing member 14 facing upward, thus positioned above the hand 2-a. In an opposite hand, shown as right hand 2-b, the practitioner retrieves or obtains a scaler 6 having a handle portion 7 and a tip 8. During the dental examination, and particularly a probing procedure, the scaler is used to probe various periodontal regions. Upon probing one periodontal region, the tip 8 may become contaminated with bacteria or other contaminants. To prevent cross-contamination, the present invention antimicrobial cleansing device 10 is designed to receive the tip 8 and expose the tip 8 to the antimicrobial agent contained therein for the purpose of disinfecting or otherwise cleaning the tip 8 prior to it being moved to a subsequent periodontal region. Once cleansed, the tip 8 can be moved to a subsequent periodontal region without introducing contaminants to the subsequent region, thus preventing or minimizing cross-contamination.

Obviously, the ring-like structures 22 and 42 shown in FIGS. 2 and 3, respectively, comprises only two of several possible designs and configurations that may perform the intended function as set forth herein, namely to support an absorbing medium about the body of a practitioner. As such, these are not intended to be limiting in any way. Indeed, one skilled in the art will recognize other devices, designs or structures that may be used to support an absorbing medium. It is intended for each of these non-recited devices, designs, and/or structures to fall within the general scope of the invention as set forth and claimed herein.

### Methods of Operation

The present invention further features various methods of using the above-described exemplary antimicrobial cleansing devices, or their equivalents, or any that would be obvious to one skilled in the art upon practicing the present invention as taught and disclosed herein.

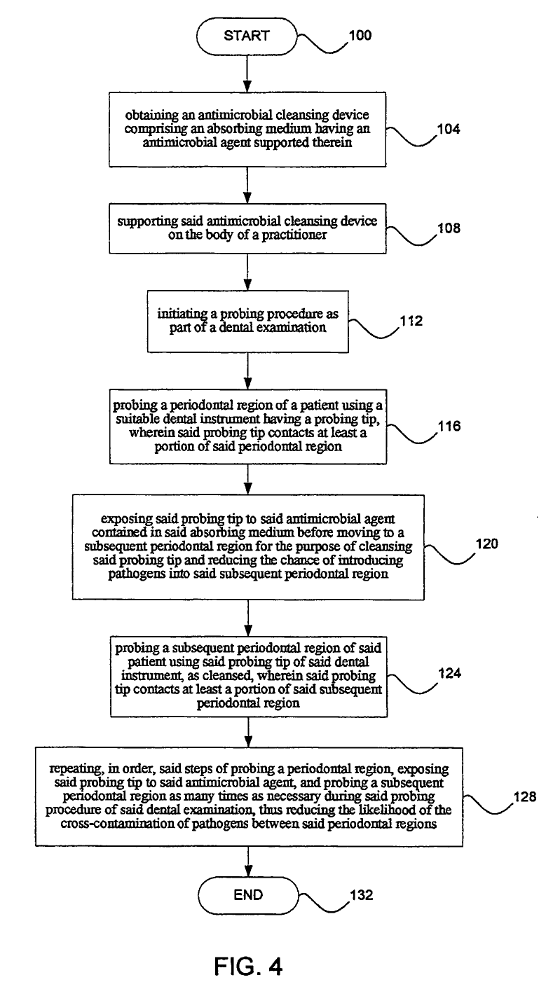

In one exemplary method of use, and with reference to FIG. 4, the present invention features a method for cleansing a dental instrument during the performance of a probing procedure on a patient as part of a dental examination. The method for cleansing comprises various steps described below. In one step, step 104, the method for cleansing includes obtaining an antimicrobial cleansing device comprising an absorbing medium having an antimicrobial agent supported therein. This step may include obtaining an absorbing medium pre-soaked with an antimicrobial agent, or one that requires the antimicrobial agent to be applied by the practitioner prior to use. If required to be applied by the practitioner, the absorbing medium should be saturated a sufficient amount so that contact of the absorbing medium with a tip will properly disinfect the tip. As described above with reference to FIGS. 1-3, the absorbing medium itself may be configured in various ways and may comprise different types of materials, such as a polymer, cloth, gauze, etc. In addition, the absorbing medium may be deformable to better expose the tip to the antimicrobial agent supported therein.

In another step, step 108, the method includes supporting the absorbing medium on or about the body of a practitioner. Supporting the absorbing medium about the body of a practitioner may include supporting the absorbing medium on the hand, wrist, arm, finger, leg, etc. of the practitioner. However, preferred embodiments will support the absorbing medium on or about the hand of the user (either a gloved or non-gloved hand). In one aspect, the step of supporting the absorbing medium on the body of the practitioner shall be understood to mean that the absorbing medium may be configured so that it attaches directly to the body, such as via a self adhesive (e.g., a double-sided adhesive layer) located on the antimicrobial disinfectant device. In another aspect, the step of supporting shall be understood to mean that the antimicrobial cleansing device may comprise or be configured with some type of means for supporting the absorbing medium, wherein the means for supporting comprises some type of structure that is releasably supported on the body of the practitioner.

Means for supporting the absorbing medium may comprise any device or apparatus known in the art. In one exemplary embodiment, means for supporting comprises a ring or ring-like structure that is fittable on the finger of the practitioner, wherein the ring includes a cup-like structure or bowl configured to contain the absorbing medium and its antimicrobial agent (see FIG. 2).

In another exemplary embodiment, means for supporting comprises a ring or ring-like structure that is fittable on the finger of the practitioner, wherein the ring includes a surface element configured to receive the absorbing medium thereon, wherein the absorbing medium is held in place by an adhesive.

In another step, step 112, the method includes initiating a probing procedure as part of a dental examination. In this step, the practitioner prepares to probe the several periodontal regions of a patient as part of a dental examination.

In another step, step 116, the method includes probing a periodontal region of a patient using a suitable dental instrument having a tip, wherein the tip contacts at least a portion of the periodontal region. The periodontal region in this step is intended to mean the first region explored or probed by the practitioner.

In still another step, step 120, the method includes exposing the tip to the antimicrobial agent contained in the absorbing medium to cleanse the tip before moving to a subsequent periodontal region for the purpose of reducing the chance of introducing pathogens into the subsequent periodontal region, and preventing cross-contamination.

Exposing the tip to the antimicrobial agent is achieved by causing the tip to come in contact with the absorbing medium supporting the antimicrobial agent (e.g., dabbing or wiping). Contact of the tip of the dental instrument with the absorbing medium may be slight or considerable. However, it should be sufficient to allow the antimicrobial agent to thoroughly cleanse the tip. Complete saturation of the tip with the antimicrobial agent may or may not be necessary.

And in an additional step, step 124, the method includes probing a subsequent periodontal region of the patient using the tip of the dental instrument, as cleansed, wherein the tip contacts at least a portion of the subsequent periodontal region. Once properly cleansed, the practitioner is free to explore or probe a subsequent periodontal region without fear of introducing pathogens or other contaminants to the subsequent region.

Naturally, the method for cleansing described above further comprises, in step 128, repeating the steps of probing a periodontal region, exposing the tip to the antimicrobial agent, and probing a subsequent periodontal region as many times as necessary during the probing procedure of the dental examination. In this way, each periodontal region probed is done with a cleansed tip.

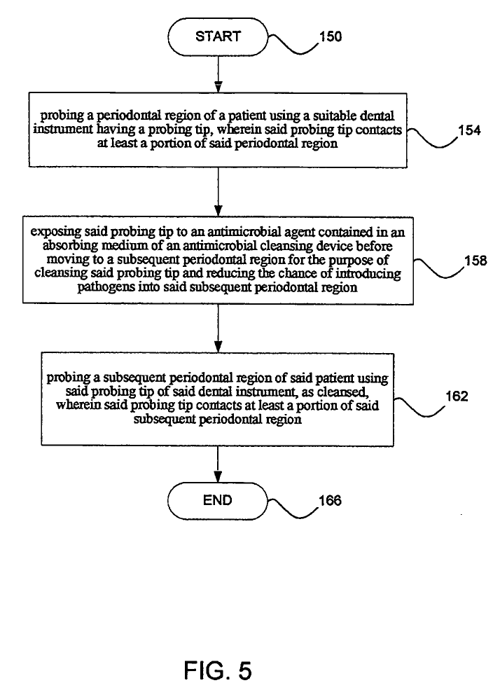

In another exemplary method of use, and with reference to FIG. 5, the present invention further features a method for reducing the cross-contamination of bacteria between periodontal regions during a probing procedure as part of a dental examination. The method for reducing cross-contamination comprises various steps described below. In one step, shown as step 154, the method includes, probing a periodontal region of a patient using a suitable dental instrument having a tip, wherein the tip contacts at least a portion of the periodontal region.

In another step, shown as step 158, the method includes, exposing the tip to an antimicrobial agent contained in an absorbing medium of an antimicrobial cleansing device before moving to a subsequent periodontal region for the purpose of cleansing the tip and reducing the chance of introducing pathogens into the subsequent periodontal region.

In still another step, shown as step 162, the method includes probing a subsequent periodontal region of the patient using the tip of the dental instrument, as cleansed, wherein the tip contacts at least a portion of the subsequent periodontal region. The steps of probing a periodontal region, exposing the tip to an antimicrobial agent, and probing a subsequent periodontal region are similar to those described above.

Again, this method may include an additional of repeating the above-described steps of probing a periodontal region, exposing the tip to the antimicrobial agent, and probing a subsequent periodontal region. The step of repeating may be performed or carried out as many times as necessary during the probing procedure.

Advantages of the present invention antimicrobial cleansing device and methods of use over prior art devices and methods are numerous. First, upon wiping or otherwise exposing the tip of the dental instrument to the sponge, the potential for cross-contamination from one pocket/tooth site to a subsequent pocket/tooth site is reduced as the tip is cleansed of contaminants or pathogens. Second, the configuration of the present invention device and the methods designed for its use reduce the risk of accidental instrument prick, stick, or puncture to the practitioner as the absorbing medium is supported above the body of the practitioner rather than in between the fingers of the practitioner. Third, the present invention device facilitates improved biomechanics and ergonomic motion, which reduces excessive repetitive muscle movement as well as minimizing stress, strain and injury to the head, neck and arms of the practitioner. Other advantages that are not specifically recited herein will be obvious and apparent to those skilled in the art. As such, these are not meant to be limiting in any way.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are expressly recited. Accordingly, the scope of the invention should be determined solely by the appended claims and their legal equivalents, rather than by the descriptions and examples given above.

What is claimed and desired to be secured by Letters Patent is:

1. A method for cleansing a dental instrument during the performance of a probing procedure on a patient as part of a dental examination, said method comprising:
obtaining an antimicrobial cleansing device comprising an absorbing medium having an antimicrobial agent supported therein;
supporting said antimicrobial cleansing device on the body of a practitioner;
initiating a probing procedure as part of a dental examination;
probing a periodontal region of a patient using a suitable dental instrument having a tip, wherein said tip contacts at least a portion of said periodontal region;
exposing said tip to said antimicrobial agent contained in said absorbing medium before moving to a subsequent periodontal region for the purpose of cleansing said tip and reducing the chance of introducing pathogens into said subsequent periodontal region; and
probing a subsequent periodontal region of said patient using said tip of said dental instrument, as cleansed, wherein said tip contacts at least a portion of said subsequent periodontal region.

2. The method of claim 1, further comprising repeating, in order, said steps of probing a periodontal region, exposing said tip to said antimicrobial agent, and probing a subsequent periodontal region as many times as necessary during said probing procedure of said dental examination, thus reducing the likelihood of the cross-contamination of pathogens between said periodontal regions.

3. The method of claim 1, wherein said periodontal region comprises one of a subgingival and coronal location.

4. The method of claim 1, wherein said obtaining comprises an antimicrobial cleansing device having an absorbing medium pre-soaked with an antimicrobial agent.

5. The method of claim 1, wherein said supporting comprises applying said absorbing medium to the body of said practitioner using a double-sided adhesive strip secured to said absorbing medium.

6. The method of claim 1, wherein said supporting comprises securing said absorbing medium within a ring-like structure configured to support said absorbing medium in an offset position from a finger of said practitioner.

7. A method for reducing the cross-contamination of bacteria between periodontal regions during a probing procedure as part of a dental examination, said method comprising:
probing a periodontal region of a patient using a suitable dental instrument having a tip, wherein said tip contacts at least a portion of said periodontal region;
exposing said tip to an antimicrobial agent contained in an absorbing medium of an antimicrobial cleansing device before moving to a subsequent periodontal region for the purpose of cleansing said tip and reducing the chance of introducing pathogens into said subsequent periodontal region;
probing a subsequent periodontal region of said patient using said tip of said dental instrument, as cleansed, wherein said tip contacts at least a portion of said subsequent periodontal region; and
repeating said steps of probing a periodontal region, exposing said tip to said antimicrobial agent, and probing a subsequent periodontal region as many times as necessary during said probing procedure.

8. An antimicrobial cleansing device for disinfecting a dental instrument during a probing procedure as part of a dental examination, said antimicrobial cleansing device comprising:
an absorbing medium configured to support an antimicrobial agent therein;
an antimicrobial agent supported within said absorbing medium and configured to cleanse a tip of a dental instrument upon contact of said tip with said absorbing medium; and
means for supporting said absorbing medium from the body of a practitioner.

9. The antimicrobial cleansing device of claim 8, wherein said absorbing medium is pre-soaked with said antimicrobial agent.

10. The antimicrobial cleansing device of claim 8, wherein said absorbing medium comprises a deformable polymer material.

11. The antimicrobial cleansing device of claim 8, wherein said absorbing medium comprises a cloth material.

12. The antimicrobial cleansing device of claim 8, wherein said antimicrobial agent comprises chlorhexadine gluconate present in an amount by weight between one-tenth of one percent and twenty percent.

13. The antimicrobial cleansing device of claim 8, wherein said antimicrobial agent comprises ethyl alcohol present in an amount by weight between one-tenth of one percent and eighty percent.

14. The antimicrobial cleansing device of claim 8, wherein said antimicrobial agent is selected from the group consisting of ethyl alcohol, high ethyl alcohol, chlorhexadine gluconate, isopropyl alcohol, povidone, iodine, sodium hypochloride, systemic antibiotics, topical antibiotics, topical antiseptics, and others.

15. The antimicrobial cleansing device of claim 8, wherein said antimicrobial agent is contained in a solution comprising:
said antimicrobial agent present in a pre-determined amount by weight; and
at least one additional ingredient, each present in a pre-determined amount by weight.

16. The antimicrobial cleansing device of claim 8, wherein said means for supporting comprises a double-sided adhesive strip located on one side of said absorbing medium, wherein a first side of said double-sided adhesive strip is configured to be applied to and secure said absorbing medium, and wherein an opposite side of said double-sided adhesive strip is configure to be applied directly to the body of the practitioner.

17. The antimicrobial cleansing device of claim 8, wherein said means for supporting comprises:
a ring-type structure comprising a ring fittable onto the finger of said practitioner; and
a bowl extending from said ring so as to be positioned above and offset from said finger of said practitioner, said bowl configured to receive and carry said absorbing medium.

18. The antimicrobial cleansing device of claim 8, wherein said means for supporting comprises a ring-type structure comprising:
a ring fittable onto the finger of said practitioner;
a surface element extending from said ring so as to be positioned above and offset from said finger of said practitioner; and
a double-sided adhesive strip located on one side of said absorbing medium and configured to be applied to said surface element to secure said absorbing medium to said ring-type structure.
